(19) United States
(12) Patent Application Publication
(10) Pub. No.: US 2021/0187915 A1
(43) Pub. Date: Jun. 24, 2021

(54) Improved Resin-rich Mica Tape

(71) Applicants: Huntsman Advanced Materials Licensing (Switzerland) GmbH, The Woodlands, TX (US); ISOVOLTA AG, Wiener Neudorf (AT)

(72) Inventors: Christian Beisele, Müllheim (DE); Sophie Colliard, Uffheim (FR); Harald Stecher, Skoerping (DK)

(21) Appl. No.: 16/093,578

(22) PCT Filed: Mar. 21, 2017
(86) PCT No.: PCT/EP2017/056636

§ 371 Date: Oct. 12, 2018

(30) Foreign Application Priority Data
Apr. 15, 2016 (EP) 16165608.7

(51) Int. Cl. B32B 19/06; C08K 3/38; C08J 5/24; B32B 19/02; B32B 5/02; H01B 3/04; H01B 3/40

(52) U.S. Cl. CPC B32B 19/06; B32B 2405/00; C08J 5/24; B32B 19/02; B32B 5/02; H01B 3/04; H01B 3/40; C08K 2003/385; C08J 2363/00; B32B 2260/021; B32B 2260/046; B32B 2262/101; B32B 2250/02; B32B 2307/204; B32B 2307/206; C08K 3/38

(57) ABSTRACT

Resin-rich mica tapes comprising one or more than one layer of mica paper and one or more than one layer of a nonmetallic inorganic fabric, in particular a glass fabric, which are pre-impregnated with an impregnation resin composition comprising an epoxy resin with more than one epoxy group, which is solid or semisolid at ambient temperature, a latent curing agent for said epoxy resin, about 5 to about 20% by weight of hexagonal boron nitride of a particle size (D50) of equal or less than about 3 μm, about 0.05 to about 1% by weight of a wetting agent and a suitable solvent which is removed after pre-impregnation of the mica tape with the impregnation resin mixture are useful to prepare electrical insulations with excellent thermal conductivity and dielectric dissipation factor.

The present invention relates to electrical insulation tapes suitable for application in large electrical engines like e.g. alternators, generators and motors, in particular to a corresponding mica tape, more specifically to an improved resin-rich mica tape and to a process for the manufacture of such tapes.

Mica tapes and their use for electrical insulation purposes are known for many years. In general, mica tapes comprise one or more layers of so-called mica paper as the main dielectric, i.e. electrically insulating component, which is a sheet-like aggregate of chemically or thermally delaminated mica particles manufactured using conventional paper-making techniques, one or more reinforcing layers usually consisting of a woven glass cloth and the like materials, and a resin system, mostly an epoxy resin system, which keeps the mentioned layers together.

For use the mica tapes are wrapped around the current-carrying parts, e.g. wires or coils, of the electrical engines to provide a cover on these parts insulating the parts against each other and/or against other electroconductive parts of the engine, with which they would otherwise have direct electric contact, and are fixed to the current-carrying parts by virtue of a matrix resin system, which is cured to provide a solid polymer mass interpenetrating the mica tapes wrapped around the current-carrying parts.

In respect of the method for fixing the tapes to the current carrying parts of the engine known mica tapes are distinguished into two major types, the so-called resin-poor mica tapes and the so-called resin-rich mica tapes.

Resin-poor mica tapes contain as such only a negligible amount of resin, just enough for fixing the mentioned mica paper and reinforcing layers of the mica tape mechanically to each other. After wrapping the current-carrying parts of a construction element of an electrical engine with a resin-poor mica tape it is therefore necessary to impregnate the wrapped construction element with a liquid thermally curable resin formulation which penetrates the mica tape and any voids between the mica tape cover and the current-carrying parts. The impregnation of such resin-poor insulation systems can e.g. be performed by trickle impregnation, hot dip rolling or vacuum pressure impregnation (VIP). Finally the construction element is baked at a temperature sufficient to thermally cure the impregnating resin. Resin-rich mica tapes, on the other hand, contain already all the resin material which is required for preparing an insulating cover and for fixing it to the current-carrying parts wrapped with these mica tapes. An impregnation of an insulating cover prepared with resin-rich tapes with additional resin as required with resin-poor tapes is therefore not necessary when using resin-rich mica tapes. The resin system on board of a resin-rich mica tape must accordingly be solid or at least semi-solid at ambient temperature, substantially solvent-free and so flexible, that the tapes can still be tightly wound around the current-carrying parts and that air bubbles developing during the wrapping can still be reliably removed from the insulation. In order to finish the insulation of current-carrying parts of the construction element prepared with resin-rich mica tapes, the construction element must only be baked (typically under pressure), after preparation of a tight and preferably bubble-free cover around its current-carrying parts, at a temperature sufficient for the final thermal cure of the matrix resin material comprised in the mica tapes.

Two areas of insulation materials development of particular interest are methods for increasing the thermal conductivity and methods of reducing the dielectric dissipation factor, tan(δ), of these materials. Both developments have machine uprating potential.

Increasing the thermal conductivity pays off in better heat transfer from the current-carrying strands to the environment thus permitting a higher current flow in the windings without increasing the thermal stress of the insulation material. Hence, thermal decomposition and destruction of the insulation material can be substantially reduced.

The dielectric dissipation factor, tan(δ), is a parameter quantifying the electric energy inherently released into the insulation material, usually in form of heat, in an alternating electrical field. It corresponds to the ratio of the electric power lost in the insulating material to the electric power applied and is therefore frequently also expressed as a percentage, for example a tan(δ) of 0.1 corresponds to 10% according to this notation. Low dissipation factors are generally desirable in order to reduce the heating-up of the insulator material during operation and thus also reduce its thermal stress. The dissipation factor is not only dependent on the chemical composition of the insulating material but also depends on several processing parameters, such as the degree of cure of the insulating material, The amount of voids, moisture and impurities etc. Tan(δ) is also indicative of the extent of water-tree damage in the insulation material. These tree shaped moisture channels, in the presence of an electrical field, can lead to the inception of partial discharges (PDs), which then eventually lead to the formation of electrical trees, which can grow to a point, where insulation failure occurs. Tan(δ) is thus a useful indicator of the condition of an electrical insulation. The dissipation factor of polymeric material for a given frequency increases with the temperature of the material. For ensuring a suitable insulation and preventing damage from the engines, it should generally be less than about 10%, even at the maximum permissible working temperature according to the insulation class of the material.

EP 0 266 602 A1 discloses resin-rich mica tapes for insulation of electrical rotating machines consisting of a mica paper layer and a glass cloth layer which layers have been pre-impregnated (i.e. impregnated before applying the tapes as insulators to a construction part of an electrical device) with a thermally curable matrix resin composition comprising e.g. an epoxy resin, a curing agent and a filler of high heat conductivity having a particle size between 0.1 and 15 μm, e.g. boron nitride of a particle size of 0.5 to 1.5 μm. Although an insulation prepared with mica tapes like these is disclosed in EP 0 266 602 A1 to provide a (dielectric) dissipation factor comparable to respective mica tapes without such fillers, it turned out in industrial practice that this is frequently not the case. In particular, the addition of fillers of such a small particle size to a solvent-based epoxy resin composition for pre-impregnation of mica tapes comprising finely divided boron nitride, often results in a significantly increased dielectric dissipation factor tan(δ) of the insulations prepared with corresponding resin-rich mica tapes. In particular, the dielectric dissipation factor at 155° C. of such insulations frequently increases to values being by far above the generally accepted upper limit of 10%, partially to values above 30% or more, so that they would not be useful in practice.

Accordingly, there is a need for resin-rich mica-tapes permitting the reproducible manufacture of electric insulations having improved thermal conductivity in combination with dielectric dissipation factors, in particular at elevated temperatures like 155° C., which are substantially equal to respective insulations with conventional thermal conductivity.

The present invention is based on the finding that an increase of the dielectric dissipation factor caused by addition of a filler of high thermal conductivity to an epoxy-based matrix resin for the manufacture of resin-rich mica tapes can be avoided by using a solvent-based epoxy resin composition comprising hexagonal boron nitride of a particle size (D₅₀) of less than 3 μm in combination with a wetting agent. Electric insulations prepared with resin-rich mica tapes which are impregnated with an impregnation resin composition according to the present invention show substantially the same dielectric dissipation factor as if they would not comprise boron nitride but a substantially improved thermal conductivity and voltage endurance.

Accordingly, the present invention relates to a resin-rich mica tape comprising at least one layer of mica paper and at least one layer of a nonmetallic inorganic fabric, in particular a glass fabric, which are pre-impregnated with an impregnation resin composition comprising an epoxy resin having more than one epoxy group, which is solid at ambient temperature, a latent curing agent for said epoxy resin, about 5 to about 20% by weight of hexagonal boron nitride of a particle size (D50) of equal or less than about 3 μm, about 0.05 to about 1% by weight of a wetting agent and a suitable solvent which is removed after pre-impregnation of the mica tape with the impregnation resin mixture.

Preferably, the impregnation resin composition comprises

about 89.95 to about 59% by weight of epoxy resin;

about 5 to about 20% by weight of boron nitride;

about 0.05 to about 1% by weight of wetting agent and

about 5 to about 20% by weight of an organic solvent.

Hexagonal boron nitride (h-BN) is also known as ‘White Graphite’ because it has similar (hexagonal) crystal structure as graphite. In addition to the hexagonal form there is a cubic modification analogous to diamond which is frequently called c-BN and a further rare modification having wurzite structure. Properties of h-BN to be mentioned are its high thermal conductivity (directional average of 0.08 cal/cm·sec·K at 293 K), low thermal expansion coefficient (1×10⁻⁶/° C. parallel to press direction and 4×10⁻⁶/° C. perpendicular to press direction), high temperature stability (1000° C. in air), high dielectric breakdown strength (35 kV/mm) and low dielectric constant (4).

The particle Size D50 is also known as the median diameter or the medium value of the particle size distribution, i.e. it is the value of the particle diameter at 50% in the cumulative distribution. It is an important parameter characterizing particle size. For example, if D50 is 3 μm, 50% of the particles in the sample are larger than 3 μm and 50% are smaller than 3 μm. D50 is usually used to represent the particle size of a group of particles. D50-values can be specified as volume diameter (D(v)) or as number diameter (D(n)). In the present application D50 means volume diameter (D(v)), i.e. 50% of the volume of boron nitride particles have a particle size of equal or less than 3 μm and 50% a particle size of more than 3 μm. D50 values can e.g. be determined by Laser diffractometry.

For the purposes of the present invention, the hexagonal boron nitride has preferably a particle size (D(v)50) of about 0.1 to about 3 μm, more preferably about 0.3 to about 3 μm, most preferably 0.5 to about 1 μm.

The hexagonal boron nitride particles are particularly useful for the purposes of the present invention, when their specific surface area determined according to the method of Brunnauer-Emmet-Teller (BET) is less than about 30 m²/g, preferably less than about 25 m²/g, for example about 15 to about 20 m²/g.

Wetting agents are chemical substances that increase the spreading and penetrating properties of a liquid by lowering its surface tension—that is, the tendency of its molecules to adhere to each other at the surface. The surface tension of a liquid is the tendency of the molecules to bond together, and is determined by the strength of the bonds or attraction between the liquid molecules. A wetting agent stretches theses bonds and decreases the tendency of molecules to bond together, which allows the liquid to spread more easily across any solid surface. Wetting agents can be made up of a variety of chemicals all of which have this tension-lowering effect. Wetting agents are also known as surface active agents (surfactants).

Suitable wetting agents for the purposes of the present application include for example:
acid esters of alkylene oxide adducts, typically acid esters of a polyadduct of 4 to 40 mol of ethylene oxide with 1 mol of a phenol, or phosphated polyadducts of 6 to 30 mol of ethylene oxide with 1 mol of 4-nonylphenol, 1 mol of dinonylphenol or, preferably, with 1 mol of compounds which are prepared by addition of 1 to 3 mol of unsubstituted or substituted styrenes to 1 mol of phenol,
polystyrene sulfonates,
fatty acid taurides,
alkylated diphenyl oxide mono- or disulfonates,
sulfonates of polycarboxylates,
the polyadducts of 1 to 60 mol of ethylene oxide and/or propylene oxide with fatty amines, fatty acids or fatty alcohols, each containing 8 to 22 carbon atoms in the alkyl chain, with alkyl phenols containing 4 to 16 carbon atoms in the alkyl chain, or with trihydric to hexahydric alkanols containing 3 to 6 carbon atoms, which polyadducts are converted into an acid ester with an organic dicarboxylic acid or with an inorganic polybasic acid,
ligninsulfonates, and
formaldehyde condensates such as condensates of ligninsulfonates and/or phenol and formaldehyde, condensates of formaldehyde with aromatic sulfonic acids, typically condensates of ditolyl ether sulfonates and formaldehyde, condensates of naphthalenesulfonic acid and/or naphthol- or naphthylaminesulfonic acids with formaldehyde, condensates of phenolsulfonic acids and/or sulfonated dihydroxydiphenyl-sulfone and phenols or cresols with formaldehyde and/or urea, as well as condensates of diphenyl oxide-disulfonic acid derivatives with formaldehyde.

There are four main types of wetting agents: anionic, cationic, amphoteric and nonionic.

Anionic, cationic and amphoteric wetting agents ionize when mixed with water. Anions have a negative charge, while cations have a positive charge. Amphoteric wetting agents can act as either anions or cations, depending on the acidity of the solution. Nonionic wetting agents do not ionize in water.

Suitable anionic wetting agents include:
sulfates, typically fatty alcohol sulfates, which contain 8 to 18 carbon atoms in the alkyl chain, e.g. sulfated lauryl alcohol;
fatty alcohol ether sulfates, typically the acid esters or the salts thereof of a polyadduct of 2 to 30 mol of ethylene oxide with 1 mol of a C₈-C₂₂fatty alcohol;
the alkali metal salts, ammonium salts or amine salts of C₈-C₂₀fatty acids, typically coconut fatty acid;
alkylamide sulfates;
alkylamine sulfates, typically monoethanolamine lauryl sulfate;
alkylamide ether sulfates;
alkylaryl polyether sulfates;
monoglyceride sulfates;
alkane sulfonates, containing 8 to 20 carbon atoms in the alkyl chain, e.g. dodecyl sulfonate;
alkylamide sulfonates;
alkylaryl sulfonates;
α-olefin sulfonates;
sulfosuccinic acid derivatives, typically alkyl sulfosuccinates, alkyl ether sulfosuccinates or alkyl sulfosuccinamide derivatives;
N-[alkylamidoalkyl]amino acids of formula

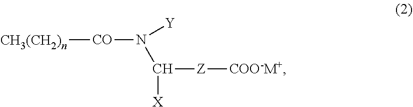

wherein

X is hydrogen, C₁-C₄alkyl or —COO⁻M⁺,

Y is hydrogen or C₁-C₄alkyl,

Z is:

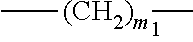

m₁ is 0 to 4,

n is an integer from 6 to 18, and

M is an alkali metal ion or an amine ion;
alkyl ether carboxylates and alkylaryl ether carboxylates of formula

CH₃—X—Y-A, (3)

wherein

X is a radical:

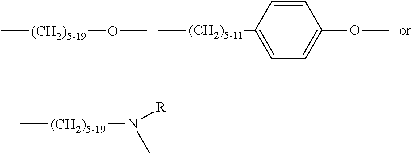

R is hydrogen or C₁-C₄alkyl,

Y is:

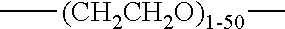

A is:

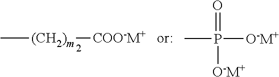

m₂ is 0 to 5, and

M is an alkali metal cation or an amine cation.

The anionic wetting agents useful according to the present invention may furthermore be fatty acid methyl taurides, alkylisothionates, fatty acid polypeptide condensates and fatty alcohol phosphoric acid esters. The alkyl radicals in these compounds preferably contain 8 to 24 carbon atoms.

Anionic wetting agents are usually obtained in the form of their water-soluble salts, such as the alkali metal, ammonium or amine salts. Typical examples of such salts are lithium, sodium, potassium, ammonium, triethylamine, ethanolamine, diethanolamine or triethanolamine salts. It is preferred to use the sodium or potassium salts or the ammonium-(NR₁R₂R₃) salts, wherein R_{1′}, R₂ and R₃ are each independently of one another hydrogen, C₁-C₄alkyl or C₁-C₄hydroxyalkyl.

Suitable amphoteric (or zwitterionic) wetting agents include imidazoline carboxylates, alkylamphocarboxy carboxylic acids, alkylamphocarboxylic acids (e.g. lauroamphoglycinate) and N-alkyl-β-aminopropionates or N-alkyl-β-iminodipropionates.

Nonionic wetting agents are typically derivatives of the adducts of propylene oxide/ethylene oxide having a molecular weight of 1000 to 15000, fatty alcohol ethoxylates (1-50 EO), alkylphenol polyglycol ethers (1-50 EO), ethoxylated carbohydrates, fatty acid glycol partial esters, typically diethylene glycol monostearate, PEG 5 glyceryl stearate; PEG 15 glyceryl stearate; PEG 25 glyceryl stearate; cetearyl octanoate; fatty acid alkanolamides and fatty acid dialkanolamides, fatty acid alkanolamide ethoxylates and fatty acid amine oxides.

The wetting agent is generally used in amounts of about 0.05 to about 1% by weight based on the entire impregnation resin composition inclusive the solvent therein, preferably in amounts of about 0.075 to about 0.75% by weight, more preferably in amounts of about 0.1 to about 0.5% by weight, e.g. 0.1 to 0.2% by weight.

Particularly preferred wetting agents include alkyl or, more preferably, alkenyl (ether) phosphates, which are anionic surfactants usually prepared by reaction of primary alcohols or ethylene oxide adducts thereof with phosphorus pentoxide and have the formula:

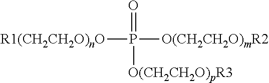

wherein R1 is a linear or branched alkyl or alkenyl group containing 4 to 22, preferably 12 to 18 carbon atoms, and R2 and R3 independently represent hydrogen or R1 and m, n and p are each 0 or a number of 1 to 10. Typical examples are phosphoric acid esters in which the alcohol component is derived from butanol, isobutanol, tert-butanol, caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol, brassidyl alcohol or mixtures thereof. Similarly, alkyl ether phosphates can be used, which are derived from adducts of an average of 1 to 10 moles of ethylene oxide with the aforementioned alcohols.

Preferably mono- and/or dialkyl phosphates can be used based on technical coconut alcohol fractions containing 8 to 18 or 12 to 14 carbon atoms. Wetting agents of this type are known to those skilled in the art and are e.g. described in DE 197 19 606 A1 and partially commercially available.

A further group of wetting agents, preferred in the same way as the aforementioned alkyl or alkenyl (ether) phosphates are reaction products of phosphoric acid or polyphosphoric acids with polyethyleneglycol mono(C₁₋₄alkyl)ether, in particular polyethyleneglycol monomethylether, and cyclic lactones like the (poly)phosphate esters of block copolymers of the following formula:

RO(C₂H₄O)ₘ(PES)ₙ—H

wherein R is C₁-₄alkyl,

PES is a polyester derived from a cyclic lactone;

m is from about 5 to about 60;

n is from about 2 to about 30;

R may be linear or branched but is preferably linear and especially methyl.

Suitable cyclic lactones include α-acetolactone, β-propiolactone, γ-butyrolactone, γ-valerolactone and, preferably, δ-valerolactone and ϵ-caprolactone (2-oxepanone), which is most preferred, in which cases PES is composed from repeating units of the following formulae:

—O—CH₂—C(═O)—; —O—(CH₂)₂—C(═O)—; —O—(CH₂)₃—C(═O)—; —O—CH(CH₃)—(CH₂)₃—C(═O)— —O—(CH₂)₄—C(═O)— and —O—(CH₂)₅—C(═O)—.

Preferably m is not greater than 40, more preferably not greater than 25, and n not greater than 20, more preferably not greater than 10, in the block copolymers of formula RO(C₂H₄O)ₘ(PES)ₙ—H, and the ratio of m:n is preferably not less than 3:1, more preferably not less than 4:1, most preferably not less than 6:1.

The molecular weight MW of the block copolymers of formula RO(C₂H₄O)ₘ(PES)ₙ—H is preferably less than 5000, more preferably less than 4000, even more preferably less than 3500 and most preferably less than 3000.

Wetting agents of this type are e.g. described in U.S. Pat. No. 6,133,366 A, US 2011/0244245 A1 or U.S. Pat. No. 5,130,463, the entire description of which is incorporated into the present description by reference including the disclosed preferences. Wetting agents of this type are also commercially available, e.g. under the trade names Byk® W 996, Byk® W 9010 or Byk® W 980 etc.

Any epoxy resin comprising more than one epoxy group, which is solid at ambient temperatures, i.e. at temperatures of about 10° C. to about 50° C., in particular of about 15° C. to about 30° C., can be used for the purposes of the present invention. The softening point (glass transition temperature T_{G}) of the pure uncured epoxy resins used for the purposes of the invention is preferably higher than about 25° C., more preferably higher than about 35° C. or 40° C.

When not indicated to the contrary, the term “solid” is to be understood in context with epoxy resins in a broad sense in this application and is intended to also include so-called quasi-solid or semi-sold substances, i.e. substances that lie along the boundary between a solid and a liquid. While similar to a solid in some respects, in that semisolids can support their own weight and hold their shapes, a quasisolid or semisolid also shares some properties of liquids, such as conforming in shape to something applying pressure to it and the ability to flow under pressure. Sometimes quasisolids and semisolids are even named semiliquids which means substantially the same. Quasisolids and semisolids are also known as amorphous solids because at the microscopic scale they have a disordered structure unlike crystalline solids.

Preferred epoxy resins for the purposes of the invention include solid polyglycidyl ethers such as the ones prepared by reacting dihydric phenols, such as bisphenols, in particular Bisphenol A and Bisphenol F, with epichlorohydrin (frequently referred to as DGEBA- or BADGE-type resins) in the so-called Taffy process (reaction of the bisphenol with less than 2 equivalent of epichlorhydrin, e.g. about 1.75 to 1.1 equivalents, in particular about 1.6 to about 1.2 equivalents, in the presence of sodium hydroxide) or advanced diglycidyl ethers obtained by advancement reaction of diglycidyl ethers of dihydric phenols phenols such as bisphenol diglycidyl ethers, in particular of Bisphenol A or Bispenol F, with an advancement agent, e.g. a dihydric phenol such as Bisphenol A or Bisphenol F. Glycidyl ethers which may be converted into solid glycidyl compounds by the advancement process, for example, are typically glycidyl ethers of mononuclear phenols such as resorcinol or hydroquinone, or polynuclear phenols, such as bis(4-hydroxyphenyl) methane (Bisphenol F), 4,4′-dihydroxybiphenyl, bis(4-hydroxyphenyl) sulfone (Bisphenol S), 2,2-bis(4-hydroxyphenyl) propane (Bisphenol A) or 2,2-bis(3,5-dibromo-4-hydroxyphenyl) propane (Tetrabromobisphenol A). Suitable solid polyglycidyl compounds of the aforementioned type have preferably an epoxy equivalent weight between about 350 and about 2500.

Particularly preferred solid polyglycidyl ethers suitable for the invention are epoxy-novolacs, which are known to be obtained by reacting novolacs including in particular phenol- and cresol-novolacs, with epichlorohydrin or β-methylepichlorohydrin under alkaline conditions, or in the presence of an acid catalyst and subsequent treatment with alkali. Novolacs are known to be condensation products of aldehydes, such as formaldehyde, acetaldehyde, chloral or furfuraldehyde, and phenols, such as phenol or phenols substituted in the nucleus by chlorine atoms or C₁-C₉alkyl groups, such as 4-chlorophenol, 2-methylphenol or 4-tert-butylphenol. Suitable solid epoxy-novolacs have preferably an epoxy equivalent weight between about 100 and about 500. The epoxy functionality of suitable epoxy-novolacs is preferably equal or greater than about 2.5, more preferably equal or greater than about 2.7, such as e.g. about 3 to about 5.5. Numerous solid or semisolid epoxyphenol-(EPN) and epoxycresol-novolacs (EPC) are commercially available, such as, for example, Araldite®EPN 1179 (functionality 2.5), Araldite®EPN 9880 (functionality >3), Araldite®EPN 1180 (functionality 3.6) or Araldite®EPN 1138 (functionality 3.6) or Araldite®ECN 9511 (functionality 2.7), Araldite®ECN 1273 (functionality 4.8), Araldite®ECN 1280 (functionality 5.1) or Araldite®ECN 1299 (functionality 5.4).

Solid polyglycidyl compounds suitable for the invention as epoxy resin component are furthermore polyglycidyl esters also prepared by the Taffy process described above using the example of poylglycidyl ethers or the advancement-process as described above but starting from monomeric polyglycidyl esters instead of ethers. For example, glycidyl esters of aliphatic polycarboxylic acids such as succinic acid, adipic acid or sebacic acid, cycloaliphatic polycarboxylic acids such as hexahydrophthalic acid, hexahydroterephthalic hexahydroisophthalic or 4-methylhexahydrophthalic, or of aromatic polycarboxylic acids such as phthalic acid or terephthalic acid, are conveniently used. Suitable solid polyglycidyl ester compounds have preferably an epoxy equivalent weight between about 250 and about 1000.

Preferably, the impregnation resin compositions according to the invention contain a solid or semisolid epoxyphenol-novolac having a functionality greater than about 3 and an epoxy equivalent weight of about 171 to about 185, such as in particular Araldite®EPN 1138.

Although it is generally preferable to use only solid or semisolid epoxy resins for the impregnation resin compositions according to the invention, it can be of advantage in certain situations to add small amounts of liquid epoxy resins such as bisphenol A or F epoxides with an epoxy equivalent weight of about 150 to about 250, cycloaliphatic epoxides with an epoxy equivalent weight of about 50 to about 400 or glycidyl esters with an epoxy equivalent weight of about 150 to about 350 and the like, to the compositions, for instance in order to improve the flexibility of the mica tapes. In such cases, however, the percentage of liquid epoxy resins should not exceed about 30% by weight based on the total amount of epoxy resins present in the impregnation resin composition and should preferably range between no more than 20% to about 5% by weight based on the total amount of epoxy resins present in the impregnation resin composition. In any case the percentage of liquid epoxy resins must be low enough to ensure that the impregnation resin composition as a whole is still semisolid at ambient temperatures after removal of the solvent.

The impregnation resin composition for the mica tapes according to the invention furthermore comprises a latent curing agent for the epoxy resin. As known, latent curing agents are substances which can initiate a homopolymerisation of the epoxy resin at elevated temperatures but remain substantially nonreactive at ambient temperatures, i.e. at temperatures of about 10° C. to about 50° C., in particular of about 15° C. to about 30° C., thus to allow a sufficient storage stability of the impregnation composition comprising the epoxy resin and the latent curing agent at ambient temperature.

Although any known latent curing agents can be used for the purposes of the present invention including e.g. tertiary amines and dicyandiamide (DICY), latent curing agents which initiate a cationic homopolymerisation of the epoxy resin are particularly preferred for the purposes of the present invention. Typically such curing agents are complexes of Lewis acids, such as ZnCl₂, SnCl₄, FeCl₃, AlCl₃ and preferably BF₃ with amines which are stable at ambient temperatures when mixed with cationically polymerizable materials like epoxy resins but release the Lewis acid upon heating which then initiates and catalyses a fast cationic homopolymerisation of the epoxy resins, including DGEBA-type resins, polyglycidyl esters and epoxy novolacs as described above. Corresponding complexes and methods for using such complexes are known to those skilled in the art for many years and are described e.g. by Lee and Neville in “Handbook of Epoxy Resins”, McGraw-Hill Inc., 1967, Chapter 11, pages 2 to 8, and by May and Tanaka in “Epoxy Resins--Chemistry and Technology”, Marcel Dekker Inc., 1973, p. 202.

Lewis acid complexes, in particular boron trifluoride complexes, that may be used in accordance with this invention are, for example, those with aliphatic, araliphatic, cycloaliphatic, or heterocyclic amines of 2 to 10 carbon atoms and having one or two primary, secondary, or tertiary amino groups. Complexes with ethylamine, diethylamine, trimethylamine, isopropylamine, di-secondary butylamine, benzylamine, isophoronediamine (3-aminomethyl-3,5,5-trimethylcyclohexylamine) or piperidine are particularly preferred.

Other latent and thermally activatable curing agents useful for the purposes of the present invention are quaternary ammonium salts of aromatic-heterocyclic compounds, which contain 1 or 2 nitrogen atoms, and complex halide anion selected from the group consisting of BF₄⁻, PF₆⁻, SbF₆⁻, SbF₅(OH)⁻, AsF₆⁻ and [Al(OC(CF3)3)4] which are preferably used in combination with a co-initiator selected from a diarylethane derivative of formula:

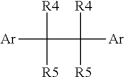

wherein Ar is phenyl, naphthyl, or C₁-C₄alkyl- or chloro-substituted phenyl, R4 is hydroxy, C₁-C₄alkoxy, —O—CO—R6 or —OSiR7R8R9, wherein R6 is C₁-C₈alkyl or phenyl, and R7, R8 and R9 are each independently of one another C₁-C₄alkyl or phenyl, and R5 is C₁-C₄alkyl or cyclohexyl or has the same meaning as Ar. Suitable quaternary ammonium salts and diarylethane derivatives are for example described for example in U.S. Pat. Nos. 4,393,185 and 6,579,566 as well as in WO 00/04075, the entire disclosure of which is incorporated by reference into the present description.

As the curing agents work as catalysts for the polymerisation of the epoxy resins, only small (catalytic) amounts of them are required. Amounts up to 5% by weight based on the epoxy resin are normally sufficient for achieving an appropriate cure of the epoxy resin. The lower limit is preferably about 0.05% by weight, more preferably 1% by weight of the latent curing agent. In case of using quaternary ammonium salts together with diarylethane derivatives as latent curing agent, the diarylethane derivative is preferably added in molar amounts corresponding approximately to the molar amount of the quaternary ammonium salts present in the impregnation resin mixture.

Preferred latent curing agents for the purposes of the invention are the aforementioned boron trifluoride complexes with amines which provide cured epoxy materials with particularly good thermal stability and excellent electrical properties, in particular when used with epoxy novolac resins.

The solvent comprised in the impregnation resin composition used according to the invention for impregnation of the mica tapes has the function to liquidate the composition of epoxy resin, boron nitride and latent curing agent so that the mica tapes can be sufficiently impregnated with the composition. After completing the impregnation, the solvent is removed usually by applying heat and/or vacuum to the impregnated mica tapes to leave the thermally curable epoxy matrix resin composition behind. Solvents with relatively low boiling points are therefore in general preferred in order to reduce the risk of a premature curing of the matrix resin composition on the tape. Depending on the heat stability of the system of epoxy resin and latent curing agent, solvents with boiling points up to about 115° C., such as toluene, can also be used in certain situations, in particular when are used in admixture with other solvents having a lower boiling point and in relatively small amounts compared to these solvents. The solvents are preferably aprotic and have a boiling point below about 100° C. more preferably below about 80° C. such as benzene, carboxylic acid esters like ethyl acetate, ketones like methylethylketone (2-butanone, MEK) or acetone, or ethers like t-butyl methyl ether (MTBE) and the like.

Carboxylic acid esters like the mentioned ethyl acetate and ketones like the mentioned methylethylketone are so-called true solvents for epoxy resins, i.e. solvents which are able to dissolve epoxy resins alone and without addition of other solvents. Other solvents like e.g. toluene are so-called latent solvents for epoxy resins which means solvents which cannot dissolve an epoxy alone but can only be used as co-solvents in admixture with a true solvent for epoxy resins. Nevertheless, such latent solvents are sometimes useful for achieving certain properties of the resin solution.

Particularly preferred solvents for the purposes of the present invention are ethyl acetate and even more preferably methylethylketone.

The mica tapes according to the invention are prepared in a manner known per se, either in a one-step process wherein piled layers of mica paper and nonmetallic inorganic fabric are impregnated or in a two-step process wherein mica paper and nonmetallic inorganic fabric are initially impregnated separately and afterwards layered, impregnated with additional resin composition and heated.

Accordingly, the invention relates to a process for the manufacture of a resin-rich mica tape, comprising the steps of placing at least one layer of mica paper on top of a layer of nonmetallic inorganic fabric, in particular a glass fabric, optionally followed by further layers of mica paper and/or inorganic fabric, impregnating the thus obtained assembly of mica paper and inorganic fabric with an impregnation resin composition as described above, removing the solvent e.g. by heating the materials to a temperature sufficiently low to avoid a premature curing of the remaining impregnation resin, optionally under vacuum, e.g. in a drying oven, and optionally cooling the thus obtained material down to ambient or lower temperatures, if the removal of the solvent was performed by heating.

The invention further relates to a process for the manufacture of a resin-rich mica tape comprising the steps of impregnating mica paper and a nonmetallic inorganic fabric, in particular a glass fabric, separately with an impregnation resin composition as described above, placing at least one layer of impregnated mica paper on top of a layer of impregnated inorganic fabric, optionally followed by further layers of impregnated mica paper and/or impregnated inorganic fabric, removing the solvent and optionally cooling the thus obtained material down to ambient or lower temperatures, if the removal of the solvent was performed by heating, impregnating the thus obtained pre-laminate of impregnated mica paper and impregnated inorganic fabric with further impregnation resin composition as described above, removing the solvent, so to connect all mentioned layers with one another, and cooling down the mica tape thus obtained to ambient or lower temperatures if the removal of the solvent was performed by heating.

The term “mica paper” is used herein in its usual sense to refer to a sheet-like aggregate of mica particles, in particular muscovite or phlogophite particles, which are optionally heated to a temperature of about 750 to about 850° C. for a certain time period (e.g. about 5 minutes to 1 hour) to partially dehydrate them and are ground into fine particles in an aqueous solution and then formed into a mica paper by conventional paper-making techniques. Mica papers suitable for the present invention have preferably a grammage of about 30 to about 350 g/m², preferably of about 50 to about 250 g/m².

The glass fabric is preferably made from so-called E-glass yarn which has a composition corresponding to about 52-56% SiO₂, about 16-25% CaO, about 12-16% Al₂O₃, about 0-1% Na₂O/K₂O, about 0-6% MgO and is the most common “all-purpose” glass type used for manufacturing glass fabric and has preferably a grammage of about 10 to about 200 g/m², more preferably of about 15 to about 125 g/m², most preferably of about 18 to 50 g/m².

In the alternative, resin-rich mica tapes according to the invention can also be prepared by impregnating conventional resin-poor mica tapes with the above described impregnation resin compositions, removing the solvent and immediately cooling down the thus obtained resin-rich mica tape according to the invention to ambient or lower temperatures. The term resin-poor mica tape as referred to above means a sheet-like composite material consisting of one or more layers of mica paper as described above which is (are) glued to a sheet-like carrier material, usually a non-metallic inorganic fabric, such as glass or alumina fabric, using only a negligible small amount (about 1 to about 10 g/m² of mica paper) of a resin, preferably an epoxy or acrylic resin or a mixture thereof. The agglutination of the mica paper and the fabric is advantageously performed in a press or a calender at a temperature above the melting point of the adhesive resin.

Removing the solvent means preferably but not necessarily to remove the solvent entirely from the impregnation resin composition. In any case the solvent must be removed to an extent that the mica tapes are not tacky any more, what normally requires the removal of at least 95, preferably at least 98 more preferably 99 to 100% by weight of the solvent.

For removal of the solvent the resin composition should preferably not be submitted to temperatures above about 125° C. in order to avoid a substantial premature curing of the impregnation resin composition during solvent removal. The oven temperatures can be slightly higher, e.g. up to about 150° C. because the evaporating solvents cause a certain cooling of the solidifying impregnation resin mass. Heating for about 1 to about 30 minutes, preferably 2 to about 10 minutes, should generally be sufficient to remove the solvent. Lower temperatures and shorter heating periods are generally preferred but depend on the specific solvents applied. If desired a vacuum can be applied to lower the temperature required for removal of the solvent. The preferred solvents like ethyl acetate and in particular methylethylketone can normally be removed by heating for about 2 to 15 minutes to temperatures of 80 to 120° C.

The finalized mica tapes according to the present invention must contain a sufficient amount of the impregnation resin to ensure that a functioning and stable insulating encasement of the electrical conductors of a construction element can be achieved by simply winding the mica tapes according to the invention around the electrical conducting parts of the construction element and thereafter heating the construction part to temperatures sufficient to achieve a cure of the resin composition comprised in the mica tapes without the need to add any further resin at this stage. To this purpose, the mica tapes should generally comprise about 20 to about 80% by weight of the solvent-free impregnation resin composition, preferably 20 to about 60% by weight, more preferably about 25 to about 50% by weight, most preferably about 27 to 45% by weight.

Mica tapes according to the invention can be produced with different thicknesses. Their nominal thickness before use is preferably between about 0.05 and about 0.4 mm, more preferably between about 0.1 and about 0.3 mm, most preferably between about 0.12 and 0.22 mm. Depending on the curing conditions, in particular the application of pressure, said nominal thickness decreases during cure by about 25 to 30%.

The resin-rich mica tapes according to the invention have a good shelf life and can easily be stored at ambient temperatures for several months before use. However, storage is preferably performed under continued cooling in order to further increase the shelf life.

For use, the mica tapes according to the invention are wound in the conventional known way around the electrical conductors of a construction element of an engine, e.g. a coil of a stator or rotor of said engine. The wrapped coil or other electric conductor is then exposed to heat and, optionally, pressure in order to cure the resin composition contained by the mica tape and to provide a thermally stable, tough cured insulation of an excellent thermal conductivity, e.g. of more than 0.35 Wm⁻¹ K⁻¹ at 90° C., exhibiting no inner voids and showing a strongly (e.g. by a factor of more than 3) increased voltage endurance.

The cure is preferably performed by applying a temperature of about 120 to about 250° C., more preferably of about 130 to about 220° C. under a pressure of preferably about 5 to about 50 bar (0.5 to 5 N/mm²), more preferably about 10 to about 30 bar (1 to 3 N/mm²), to the construction element for a time period of preferably about 0.5 to about 15 hours, more preferably about 2 to 8 hours, e.g. in a heated press.

The following examples further illustrate the present invention:

### Description of Components Used in the Following Examples

Araldite® EPN 1138 N80: Mixture of 80% polyfunctional epoxidized phenol novolac resin with 175-182 g/eq and 20% MEK; supplier: Huntsman

Aradur® HZ 5933: solution of BF₃*(3-aminomethyl-3,5,5-trimethylcyclohexylamine) complex in methanol, supplier Huntsman

BN (type 1): Hexagonal BN with a D50 of 0.5 micron and a BET of 20 m²/g, supplier: 3M

BN (type 2): Hexagonal BN with a D50 of 0.9 micron and a BET of 20 m²/g, supplier: Momentive

BN (type 5): Hexagonal BN with a D50 of 2 micron and a BET of 10 m²/g, supplier: St. Gobain

Byk® W996: Wetting agent based on reaction products of polyphosphoric acids with 2-oxepanone (ϵ-caprolactone) and polyethyleneglycolmonomethyl ether (Cas Nr. 162627-21-6) and solvents, supplier: Byk Chemie.

### Example 1

### Reference Without Boron Nitride

An impregnation resin mixture is prepared based on 50.0 g Araldite® EPN 1138 N80 which is mixed with 1.38 g Aradur®HZ 5933 in 5.0 g methylethylketone.

100×100 mm of calcined mica paper of a grammage of 120 g/m² are impregnated with 0.7 g of the impregnation resin mixture. The solvent is removed by heating the mica paper sample in an oven for 1 min at 120° C. A layer of glass fabric style 771 (grammage: 32 g/m²) is then applied to the impregnated mica paper and an additional 0.7 g of the impregnation resin mixture is applied and the sample dried at 120° C. for 2 min.

Specimens of hand samples are prepared by curing in a heated press at 160° C. for 4 h.

For comparative experiments of production samples the commercial standard resin-rich mica tape Calmicaglas® 0409 (supplier: Isovolta) is used.

Test bars are wrapped on an iron core. The tape width is 25 mm, taping tension is 70 N. 16 half-lapped layers are taped. The test bars are cured in a heated press to a insulation thickness of 2.0 mm. Pressure is applied after a 7 min preheating phase. Curing is conducted at 160° C. for 1 h.

### Example 2

### Reference With BN (Type 1) But Without Wetting Agent

The samples are prepared as follows:

A resin mixture is prepared based on 5.0 g LME 11007 (a mixture of 500 g Araldite® EPN 1138 N80 with 100 g BN(type1) which is further mixed with 1.25 g Aradur® HZ 5933 and 5.0 g methylethylketone.

100×100 mm of calcined mica paper of a grammage of 120 g/m² are impregnated with 0.7 g of the impregnation resin mixture. The solvent is removed by heating the mica paper sample in an oven for 1 min at 120° C. A layer of glass fabric style 771 (grammage: 32 g/m²) is then applied to the impregnated mica paper and an additional 0.7 g of the impregnation resin mixture is applied and the sample dried at 120° C. for 2 min.

Specimens of hand samples are prepared by curing in a heated press at 160° C. for 4 h.

The mica paper specimens showed optical defects in form of bubbles on the surface. The glass/mica laminates exhibited voids also between the layers.

### Example 3

### According to the Invention With BN (Type 1) and Wetting Agent

The samples are prepared as follows:

A resin mixture was prepared based on 50.0 g LME 11033 (a mixture of 500 g Araldite® EPN 1138 N80 with 100 g BN(type1) and 1.0 g Byk® W996 wetting agent) which is further mixed with 1.25 g Aradur® HZ 5933 and 5.0 g methylethylketone.

100×100 mm of calcined mica paper of a grammage of 120 g/m² are impregnated with 0.7 g of the impregnation resin mixture. The solvent is removed by heating the mica paper sample in an oven for 1 min at 120° C. A layer of glass fabric style 771 (grammage: 32 g/m²) is then applied to the impregnated mica paper and an additional 0.7 g of the impregnation resin mixture is applied and the sample dried at 120° C. for 2 min.

Specimens of hand samples are prepared by curing in a heated press at 160° C. for 4 h. The aspect is good.

To test the processability and properties under standard production conditions, a sample production is conducted on production machines. The resin content is adjusted to 100 g/m². In production process the mica paper and glass fabric are impregnated simultaneously in one step and the solvent is removed to yield the mica tape.

Test bars are wrapped on an iron core. The tape width is 25 mm; taping tension is 70 N. 16 half-lapped layers are taped. The test bars are cured in a heated press to an insulation thickness of 2.0 mm. Pressure is applied after a 7 min preheating phase. Curing is conducted at 160° C. for 1 h. The aspect is good.

### Comparison of the Properties of the Samples Obtained in Comparative Examples 1 and 2 Versus the Samples of Example 3 According to the Invention

The dielectric dissipation factor (tan(δ)) of the cured hand samples at room temperature (RT) and at 155° C. are determined according to IEC 60250 in Tettex instrument using a guard ring electrode at 400 V/50 Hz. Furthermore, the thermal conductivity at 90° C. of the hand samples is measured using an Anter Unitec device and the voids in the pressed material are detected with optical microscope.

The thickness of the production samples is determined according to IEC 60371-2, the voltage endurance of these samples according to IEEE 1053 and the breakdown voltage according to IEC 60243-1.

The results are shown in the following table:

| | | Example 1 | Example 2 | Example 3 |
|---|---|---|---|---|
| | | (comparative) | (comparative) | (invention) |
| Hand | tan(δ) at | ≈1.6 | 1.1 | 1.0 |
| samples | RT [%] | | | |
| | tan(δ) at | 5 | 31.7 | 5 |
| | 155° C. [%] | | | |
| | Thermal | 0.24 | 0.35 | 0.4 |
| | conductivity | | | |
| | at 90° C. | | | |
| | [Wm⁻¹K⁻¹] | | | |
| | Voids in | no | yes | no |
| | pressed | | | |
| | material | | | |
| Production | Thickness | 0.18 | — | 0.18 |
| samples | [mm] | | | |
| | Voltage | 28.96 | — | 90 |
| | endurance | | | |
| | [h] | | | |
| | (15 kV/mm) | | | |
| | Breakdown | 62.4 | — | 54.9 |
| | voltage | | | |
| | [kV] | | | |

It can be seen that the thermal conductivity of the samples unsurprisingly increases with the addition of the boron nitride. The dielectric dissipation factor of the samples, on the other hand, while comparable at room temperature, significantly increases at 155° C., when only the hexagonal boron nitride powder is added to the impregnation resin mixture of Example 1, so that this impregnation resin composition would be inoperative in technical practice. Surprisingly however this increase of the dielectric dissipation factor disappears again, when a wetting agent is added in addition to the boron nitride powder according to the present invention as shown be Example 3.

Surprisingly, the voltage endurance of the insulating material according to the invention is significantly increased in comparison to the conventional material without boron nitride.

### Example 4

### According to the Invention With BN (Type 2) and Wetting Agent

The samples are prepared as follows:

A resin mixture is prepared by mixing 500 g of Araldite® EPN 1138 N80 with 100 g BN(type2) and 1.0 g Byk® W996 wetting agent with a high shear mixer at ambient temperature for 55 min.

50 g of this mixture is further mixed with 1.25 g Aradur® HZ 5933 and 5.0 g methylethylketone.

100×100 mm of calcined mica paper of a grammage of 120 g/m² are impregnated with 0.7 g of the impregnation resin mixture. The solvent is removed by heating the mica paper sample in an oven for 1 min at 120° C. A layer of glass fabric style 771 (grammage: 32 g/m²) is then applied to the impregnated mica paper and an additional 0.7 g of the impregnation resin mixture is applied and the sample dried at 120° C. for 2 min.

Specimens of hand samples are prepared by curing in a heated press at 160° C. for 4 h.

The aspect is of the pressed sample is good with no voids. The thermal conductivity at 90° C. of the hand sample is 0.39 Wm⁻¹ K⁻¹, measured using an Anter Unitec device.

### Example 5

### According to the Invention With BN (Type 5) and Wetting Agent

The samples are prepared as follows:

A resin mixture is prepared by mixing 500 g of Araldite® EPN 1138 N80 with 100 g BN (type5) and 1.0 g Byk® W996 wetting agent with a high shear mixer at ambient temperature for 5 minutes.

50 g of this mixture is further mixed with 1.25 g Aradur® HZ 5933 and 5.0 g methylethylketone.

100×100 mm of calcined mica paper of a grammage of 120 g/m² are impregnated with 0.7 g of the impregnation resin mixture. The solvent is removed by heating the mica paper sample in an oven for 1 min at 120° C. A layer of glass fabric style 771 (grammage: 32 g/m²) is then applied to the impregnated mica paper and an additional 0.7 g of the impregnation resin mixture is applied and the sample dried at 120° C. for 2 min.

Specimens of hand samples are prepared by curing in a heated press at 160° C. for 4 h.

The aspect is of the pressed sample is good with no voids. The thermal conductivity at 90° C. of the hand sample is 0.38 Wm⁻¹ K⁻¹, measured using an Anter Unitec device.

1.-14. (canceled)

15. A resin-rich mica tape comprising at least one layer of mica paper and at least one layer of a nonmetallic inorganic fabric, wherein the mica paper and nonmetallic inorganic fabric each contain an impregnation resin composition comprising (i) an epoxy resin having more than one epoxy group, (ii) a latent curing agent for said epoxy resin, (iii) hexagonal boron nitride of a particle size (D50) of equal or less than about 3 μm, and (iv) a wetting agent.

16. The resin-rich mica tape according to claim 15, wherein said impregnation resin composition comprises:
about 59 to about 89.95% by weight of the epoxy resin;
about 5 to about 20% by weight of the hexagonal boron nitride;
about 0.05 to about 1% by weight of the wetting agent; and
about 5 to about 20% by weight of a solvent, wherein the solvent is removed after being impregnated into the mica paper and nonmetallic inorganic fabric.

17. The resin-rich mica tape according to claim 16, wherein the wetting agent is present in an amount from about 0.075 to about 0.75% by weight based on the impregnation resin composition.

18. The resin-rich mica tape according to claim 15, wherein the wetting agent is selected from (i) alkyl or alkenyl (ether) phosphates and (ii) reaction products of phosphoric acid or polyphosphoric acids with polyethyleneglycol mono(C₁-C₄alkyl)ether and cyclic lactones.

19. The resin-rich mica tape according to claim 15, wherein the wetting agent is selected from compounds having the following formula 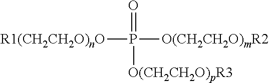
wherein R1 is a linear or branched alkyl or alkenyl group containing 4 to 22 carbon atoms;
R2 and R3 are independently selected from hydrogen or a linear or branched alkyl or alkenyl group containing 4 to 22 carbon atoms; and
m, n and p are each 0 or a number in a range of from 1 to 10.

20. The resin-rich mica tape according to claim 15, wherein the wetting agent is selected from reaction products of phosphoric acid or a polyphosphoric acid with block copolymers of the following formula:
RO(C₂H₄O)ₘ(PES)ₙ—H
wherein R is a linear or branched C₁-₄alkyl,
PES is a polyester derived from a cyclic lactone;
m is from about 5 to about 60;
n is from about 2 to about 30.

21. The resin-rich mica tape according to claim 15, wherein the epoxy resin is a solid or semisolid epoxy novolac.

22. The resin-rich mica tape according to claim 15, wherein the latent curing agent is a complex of boron trifluoride with an amine selected from aliphatic, araliphatic, cycloaliphatic and heterocyclic amines having 2 to 10 carbon atoms and one or two primary, secondary, or tertiary amino groups.

23. The resin-rich mica tape according to claim 22, wherein the amine of the boron trifluoride complex is selected from ethylamine, diethylamine, trimethylamine, isopropylamine, di-secondary butylamine, benzylamine, isophoronediamine, and piperidine.

24. The resin-rich mica tape according to claim 15, wherein the latent curing agent is present in an amount of 0.05 to 5% by weight based on the epoxy resin.

25. The resin-rich mica tape according claim 16, wherein the solvent is an aprotic solvent having a boiling point below about 100° C.

26. The resin-rich mica tape according to claim 25, wherein the solvent comprises ethyl acetate or methylethylketone.

27. A process for the manufacture of a resin-rich mica tape, comprising:
a) placing at least one layer of mica paper on top of a layer of nonmetallic inorganic fabric to form a pre-laminate,
b) impregnating the pre-laminate with an impregnation resin composition comprising (i) an epoxy resin having more than one epoxy group, (ii) a latent curing agent for said epoxy resin, (iii) hexagonal boron nitride of a particle size (D50) of equal or less than about 3 μm, (iv) a wetting agent, and (v) a solvent,
c) removing the solvent, and, optionally cooling the impregnated pre-laminate.

28. A process for the manufacture of a resin-rich mica tape, comprising:
a) individually impregnating a mica paper and a nonmetallic inorganic fabric with an impregnation resin composition comprising (i) an epoxy resin having more than one epoxy group, (ii) a latent curing agent for said epoxy resin, (iii) hexagonal boron nitride of a particle size (D50) of equal or less than about 3 μm, (iv) a wetting agent, and (v) a solvent;
b) removing the solvent and, optionally, cooling the impregnated mica paper and nonmetallic inorganic fabric;
c) placing at least one layer of the impregnated mica paper on top of a layer of the impregnated inorganic fabric to form a pre-laminate, and
d) impregnating the pre-laminate with an additional amount of the impregnation resin composition and thereafter removing the solvent and, optionally, cooling the impregnated pre-laminate.
